(19) United States
(12) Patent Application Publication
(10) Pub. No.: US 2002/0158447 A1
(43) Pub. Date: Oct. 31, 2002

(54) BODY-IN-WHITE FOR A MOTOR VEHICLE WITH WINDOW BAY ACCOMMODATING STRUCTURE AND METHOD OF MAKING SAME

(76) Inventors: WERNER BACHER, SINDELFINGEN (DE); ANDREAS HIRTH, DIEHLHEIM (DE); IAN TURNER, RENNINGEN (DE)

Correspondence Address: Richard L. Mayer, Esq., KENYON & KENYON, One Broadway, New York, NY, 10004, US

(21) Appl. No.: 09/427,713

(22) Filed: Oct. 27, 1999

(30) Foreign Application Priority Data
Oct. 27, 1998 (DE) 198 49 4890-21

(51) Int. Cl. B60R 21/16

(52) U.S. Cl. 280/728.2

(57) ABSTRACT

Inflatable head protector units are located at a unitized passenger compartment in the vicinity of roof frame sections with an energy-absorbent molded part being provided as a head impact protector at the level of each inflatable head protector unit. The molded part is designed as a launch ramp to guide an expanding airbag of the head protector unit into the desired protective position and located so that the molded part remains positioned at least largely dimensionally stably during the expansion of the airbag.

### BACKGROUND AND SUMMARY OF THE INVENTION

This application claims the priority of German application 198 49 489.0, filed in Germany on Oct. 27, 1998, the disclosure of which is expressly incorporated by reference herein.

The invention relates to a body-in-white for a motor vehicle with roof frame sections disposed in the vicinity of a passenger compartment above the window cutouts, with inflatable head protector units associated therewith, with an energy-absorbing molded part being provided as a head impact protector at the level of each inflatable head protector unit.

A body-in-white of this kind for a motor vehicle is known from German Patent Document No. DE 196 12 227 A1. The self-supporting body-in-white has a passenger compartment provided with laterally disposed roof frame sections above side door cutouts. Inflatable head protector units are located at the roof frame sections, each said unit being provided with an airbag that unfolds suddenly in a vehicle collision. Each airbag expands downward from the roof frame area to block the impact of the head of a vehicle occupant against a door frame area or the door frame section or a side window of the corresponding side door in a vehicle side collision. In order to ensure that reliable head protection is provided when a head strikes a head protector unit that does not expand, a separate deformation element is provided at the level of the inflatable head protector unit, said element containing the airbag of the head protector unit and holding it in its folded position. The deformation element is deformed by the sudden expansion of the airbag, clearing the way for the expanding airbag to emerge downward.

A goal of the invention is to provide a body-in-white of the type recited at the outset that offers improved impact protection for the head of a vehicle occupant.

This goal is achieved by the molded part being shaped as a launching ramp to guide an expanding airbag of the head protector unit into the desired protective position and is located so that the molded part remains at least largely dimensionally stably positioned during the expansion of the airbag.

As a result of the solution according to the invention, deliberate guidance of the expanding airbag is achieved so that the bag can be transferred reliably into the suitable protective position. The molded part thus performs a double function, since in addition to its function as a launching ramp, the energy-absorbing function remains ensured during a head impact if the airbag does not expand. The molded part is located and shaped so that the forces generated by the abruptly expanding airbag are accepted at least largely dimensionally stably, but at the same time the forces produced by a head impact from a correspondingly different direction lead to a deformation of the molded part with simultaneous energy absorption.

In certain preferred embodiments of the invention, the molded part is located flanking the head protecting unit in such fashion that accessibility to the head protecting unit is guaranteed. In contrast to the prior art, the molded part therefore does not form the cover for the airbag but instead allows access to the head protector unit. The airbag of the head protector unit must therefore be provided with an additional removable cover or guard that holds the airbag in the folded position.

According to another advantageous feature of preferred embodiments of the invention, the molded part is connected to the body at a roof frame section. This design advantageously permits integration of the molded part during the manufacture of the body-in-white. The molded part can be connected with the corresponding part of the body-in-white either by mounting elements or permanently by welding.

According to another advantageous feature of preferred embodiments of the invention, the molded part is designed as an integral part of the head protector unit. As a result, the molded part can be mounted jointly with the head protector unit in the vehicle and preferably to the body at a corresponding portion of the roof frame or another suitable part of the body. By integrating the molded part into a corresponding housing of the head protector unit, a reduced assembly cost can be achieved when installing the head protector unit in the passenger compartment.

Other objects, advantages and novel features of the present invention will become apparent from the following detailed description of the invention when considered in conjunction with the accompanying drawings.

### BRIEF DESCRIPTION OF THE DRAWINGS

FIG. 1 shows schematically in a perspective view a passenger compartment portion of an embodiment of a body-in-white according to the invention above a belt line of the automobile; and

FIG. 2 shows in an enlarged view a cross section through a roof frame area of the body-in-white according to FIG. 1 at the level of cutouts II in FIG. 1.

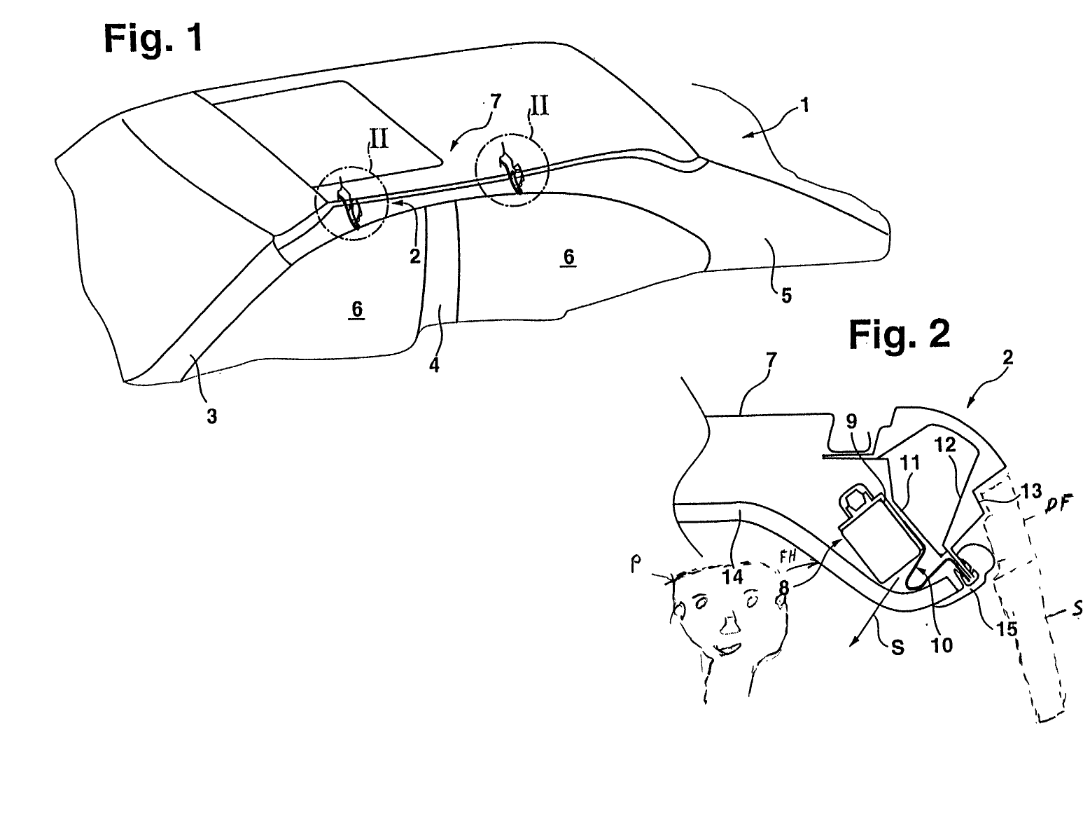

### DETAILED DESCRIPTION OF THE INVENTION

A body-in-white for an automobile is made unitized in a basically known manner and has a passenger compartment 1. Passenger compartment 1, likewise in a manner known of itself, is composed of front supporting pillars 3 in the form of A-pillars, middle supporting pillars 4 in the form of B-pillars, and rear supporting pillars 5 in the form of C-pillars. Supporting pillars 3, 4, and 5 terminate in a roof area in a roof frame structure 2. In addition to lateral roof frame portions, the roof frame structure 2, in a manner not shown in greater detail, has a plurality of roof cross members that provide adequate stiffening with respect to the opposite side of the vehicle. Roof frame structure 2 is provided with roof cladding 7. Corresponding window cutouts 6 for side windows are provided between supporting pillars 3, 4, and 5. The window cutouts 6 are integrated into the side vehicle doors, at least between the A-pillars and the B-pillars. At the bottom, supporting pillars 3, 4, and 5 terminate in a likewise known fashion in a floor structure.

At least one head protector unit 8 is associated with the roof frame sections 2 on each side of the vehicle above the window cutouts 6. Head protector unit 8 extends at least in the lengthwise direction of the vehicle over the length of a seat position within the passenger compartment. With only a single head protector unit 8 on each side, this unit can be provided simultaneously for both the front and rear seat positions.

The (at least one) head protector unit 8 has an airbag that can be inflated suddenly. The basic design of such a head protector unit 8 will not be described in greater detail since it is generally known. Head protector unit 8 has a stable supporting angle 9 that is mounted on an energy-absorbent molded sheet metal part 10. Molded sheet metal part 10 has a V-shaped profile and accepts supporting angle 9 in the vicinity of one of its legs. The molded sheet metal part 10 is secured to the body by the other leg, and is welded to corresponding flanges of the roof frame part 2 designed as a roof rail. The roof frame section 2 is designed in the form of three shells, comprising an inner shell 11, a reinforcing shell 12, and an outer shell 13. The three shells 11 to 13 are welded to one another both in the area of the transition to the roof cladding 7 and also in an outer connecting area by corresponding flanges. In the outer connecting area, the molded sheet metal part 10 is welded as well, with the corresponding legs of the molded sheet metal part 10, which likewise forms a flange, being connected with the flanges of shells 11 to 13. The V-shaped profile section of the shaped sheet metal part 10 extends diagonally downward and inward toward the passenger compartment, with the surface that faces head protector unit 8 forming a flank resembling a launch ramp which steers the airbag when a vehicle collision occurs, said bag expanding suddenly in the direction of arrow S following suitable triggering, thus producing a specifically directed unfolding of the airbag.

In FIG. 2, a vehicle occupant or passenger head P is illustrated in dash lines, depicting an impact direction FH against the roof frame area. FIG. 2 also schematically depicts a side window SW, which may be framed at the top by a door frame section DF.

Shaped sheet metal part 10 is additionally shaped so that when the head of a vehicle occupant P impacts this roof frame area in a direction FH (FIG. 2) without previous expansion of the airbag, this shaped sheet metal part 10 yields to absorb energy and is consequently deformed.

Head protector unit 8 comprising shaped sheet metal part 10 and roof frame section 2 is covered by a flat foamed or molded part 14 that forms a roof liner for the passenger compartment. Foamed or pressed part 14 abuts the V-profile section of shaped sheet metal part 10 and continues up to the flange area of roof frame section 2 in the outer connecting area. In this outer connecting area, the foamed or molded part is held by a shaped plastic tab 15 that is inserted into the flange area. When the airbag expands, the flexible foam or molded part is pushed away downward so that it no longer is in contact between the V-profile section of the shaped sheet metal part 10 and the shaped plastic tab 15. The foamed or molded part 14 however poses no significant resistance to the expansion of the airbag, since it is to be flexible or to yield in another way designed without a greater expenditure of force.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. Body-in-white for a motor vehicle with roof frame sections located in the vicinity of a passenger compartment above window cutouts, with inflatable head protector units associated with said sections, with an energy-absorbent molded part being provided at the level of each inflatable head protector unit as a head impact protector,
wherein the molded part is designed as a launch ramp to guide an expanding airbag of the head protector unit into the desired protective position and disposed so that molded part remains at least largely dimensionally stably positioned during the expansion of the airbag.

2. Body-in-white according to claim 1, wherein the molded part is located in a flanking manner relative to the respective head protector unit so that accessibility to said head protector unit is guaranteed.

3. Body-in-white according to claim 1, wherein the molded part is connected on the body side with a roof frame section.

4. Body-in-white according to claim 1, wherein the molded part is designed as an integral part of the head protector unit.

5. Body-in-white according to claim 1, wherein the molded part is made of sheet metal, preferably sheet steel.

6. Body-in-white according to claim 1, wherein the molded part is made of plastic.

7. Passenger motor vehicle assembly comprising:
a passenger compartment with a roof frame section disposed above side window cutouts opening into the passenger compartment,
an inflatable head protector unit disposed at the roof frame section, and
an energy absorbing molded part provided at a level of the head protector unit and operable as a vehicle occupant head impact protector,
wherein said molded part is configured to also form a substantially dimensionally stable airbag launching ramp to guide an expanding airbag of the head protector unit toward an occupant protecting position between the occupant and a vehicle side wall and window section.

8. Passenger motor vehicle assembly according to claim 7, wherein the molded part is located in a flanking manner relative to the respective head protector unit so that accessibility to said head protector unit is guaranteed.

9. Passenger motor vehicle assembly according to claim 7, wherein the molded part is connected on the body side with a roof frame section.

10. Passenger motor vehicle assembly according to claim 7, wherein the molded part is designed as an integral part of the head protector unit.

11. Passenger motor vehicle assembly according to claim 7, wherein the molded part is made of sheet metal, preferably sheet steel.

12. Passenger motor vehicle assembly according to claim 7, wherein the molded part is made of plastic.

13. Passenger motor vehicle assembly according to claim 8, wherein the molded part is connected on the body side with a roof frame section.

14. Passenger motor vehicle assembly according to claim 13, wherein the molded part is designed as an integral part of the head protector unit.

15. Passenger motor vehicle assembly according to claim 13, wherein the molded part is made of sheet metal, preferably sheet steel.

16. Passenger motor vehicle assembly according to claim 14, wherein the molded part is made of plastic.

17. A method of making a body-in-white for a passenger vehicle comprising:
forming a unitized body with a roof frame section disposed above side window cutouts in a side wall adjacent a passenger compartment,
attaching an inflatable head protector unit with said roof frame section, said head protector unit including an inflatable airbag which in use expands downwardly to a protective position between a vehicle occupant and the side wall, and
forming a molded energy absorbing part and connecting the molded part to the roof frame sections at a level of the head protector unit so as to be operable as a vehicle occupant head impact protector,
wherein said molded part is configured to also form a substantially dimensionally stable airbag launching ramp to guide an expanding airbag of the head protector unit toward an occupant protecting position between the occupant and a vehicle side wall and window section.

18. A method according to claim 17, wherein said molded part is a sheet metal part which is welded to said roof frame sections and to a supporting angle of the head protection unit.
